(19) United States
(12) Patent Application Publication
(10) Pub. No.: US 2025/0310120 A1
(43) Pub. Date: Oct. 2, 2025

(54) COMPUTING SYSTEM DATA POSTURE ANALYSIS USING SIGNATURE ENCODERS WITH SIMILARITY QUERIES

(71) Applicant: Proofpoint, Inc., Sunnyvale, CA (US)

(72) Inventors: Jagadeesh Mallikarjun Dyaberi, Bangalore (IN); Aayush Naik, Bangalore (IN); Ravishankar Ganesh ITHAL, Los Altos, CA (US)

(73) Assignee: Proofpoint, Inc., Sunnyvale, CA (US)

(21) Appl. No.: 19/086,729

(22) Filed: Mar. 21, 2025

(30) Foreign Application Priority Data
Mar. 27, 2024 (IN) 202411024328

(51) Int. Cl. H04L 9/32; G06F 16/245; G06F 16/25

(52) U.S. Cl. CPC H04L 9/3247; G06F 16/245; G06F 16/258

(57) ABSTRACT

The technology disclosed relates to a computer-implemented method for detecting data posture of a computing environment. The method includes performing a scan of one or more data structures, detecting a plurality of classified data substructures based on the scan of the one or more data structures and, for each respective data substructure, transforming a plurality of data items from the respective data substructure into a respective data substructure signature using a signature encoder. The method includes applying a similarity query to identify a set of data substructures, from the plurality of classified data substructures, having a threshold level of similarity based on data substructure signatures associated with the set of data substructures.

### CROSS-REFERENCE TO RELATED APPLICATION

The present application claims the benefit of Indian Application No. 202411024328, filed Mar. 27, 2024, the content of which is hereby incorporated by reference in its entirety.

### FIELD OF THE TECHNOLOGY DISCLOSED

The technology disclosed herein generally relates to data posture analysis of a computing environment using signature encoders and identifying similarity measures between data sets. More specifically, but not by limitation, the present disclosure relates to improved systems and methods of data security and posture management (DSPM), cloud security posture management (CSPM), cloud infrastructure entitlement management (CIEM), cloud-native application protection platform (CNAPP), and/or cloud-native configuration management database (CMDB).

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

Cloud computing provides on-demand availability of computer resources, such as data storage and compute resources, often without direct active management by users. Thus, a cloud environment can provide computation, software, data access, and storage services that do not require end-user knowledge of the physical location or configuration of the system that delivers the services. In various examples, remote servers can deliver the services over a wide area network, such as the Internet, using appropriate protocols, and those services can be accessed through a web browser or any other computing component.

Examples of cloud storage services include Amazon Web Services™ (AWS), Google Cloud Platform™ (GCP), and Microsoft Azure™, to name a few. Such cloud storage services provide on-demand network access to a shared pool of configurable resources. These resources can include networks, servers, storage, applications, services, etc. The end-users of such cloud services often include organizations that have a need to store sensitive and/or confidential data, such as personal information, financial information, medical information. Such information can be accessed by any of a number of users through permissions and access control data assigned or otherwise defined through administrator accounts.

The discussion above is merely provided for general background information and is not intended to be used as an aid in determining the scope of the claimed subject matter.

### SUMMARY

The technology disclosed herein generally relates to data posture analysis of a computing environment using signature encoders and identifying similarity measures between data sets. In one example, a method includes performing a scan of one or more data structures, detecting a plurality of classified data substructures based on the scan of the one or more data structures and, for each respective data substructure, transforming a plurality of data items from the respective data substructure into a respective data substructure signature using a signature encoder. The method includes applying a similarity query to identify a set of data substructures, from the plurality of classified data substructures, having a threshold level of similarity based on data substructure signatures associated with the set of data substructures.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which:

FIG. 1 is a block diagram illustrating one example of a cloud architecture.

FIG. 2 is a block diagram illustrating one example of a cloud service.

FIG. 3 is a block diagram illustrating one example of a data security posture analysis system.

FIG. 4 is a block diagram illustrating one example of a deployed scanner.

FIG. 5 is a flow diagram showing an example operation of on-boarding a cloud account and deploying one or more scanners.

FIG. 6 is a block diagram illustrating one example of a database substructure similarity detection component.

FIG. 7 is a flow diagram illustrating one example of scanning performed by a data scanner deployed in a computing environment.

FIG. 8 is a flow diagram illustrating one example of scanning database substructure in a computing environment.

FIG. 9 is a flow diagram illustrating one example of determining database substructure similarity.

FIG. 10 is a simplified block diagram of one example of a client device.

FIG. 11 shows an example computer system.

### DETAILED DESCRIPTION

The following discussion is presented to enable any person skilled in the art to make and use the technology disclosed, and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown, but is to be accorded the widest scope consistent with the principles and features disclosed herein.

Computing environments, such as cloud environments, are used by organizations or other end-users to store a wide variety of different types of information in many contexts and for many uses. This data can often include sensitive and/or confidential information, and can be the target for malicious activity such as acts of fraud, privacy breaches, data theft, etc. These risks can arise from individuals that are both inside the organization as well as outside the organization.

The information stored in the computing environments can be voluminous. For instance, an organization may store large quantities of data in database tables or other data structures across a number of storage resources in a cloud environment. Within those data structures, classified data substructures organize segments of data within the larger data framework, and can be identified and categorized based on specific criteria or attributes. These substructures can include various forms of data organization, such as tables, records, fields, or any other logical grouping of data elements. The classification process can be automatic or manual, and can involve analyzing the data to determine characteristics of the data, such as data type, sensitivity, or relevance to certain operations or queries.

For sake of illustration but not by limitation, in the context of a database table, classified data substructures include a number of columns that can store a wide variety of different information. Each column has a plurality of data items defined in the rows of the table. Some of this information can be sensitive and subject to data retention policies and/or data access restriction to prevent data breaches or other surreptitious actions. It can be difficult to track where this data resides within the computing environment, especially when data is copied between database columns. Given the large number of data operations that occur in the computing environment, it can further be difficult to track these data operations. Comparing database columns to identify where data of interest from one column may reside in another column can be tedious, time-consuming, and inefficient, and is especially challenging due to the voluminous and distributed nature of databases.

The present technology disclosed herein relates to detection and analysis of data posture of a computing environment using signature encoders to identify similarity measures between data sets. Using data scanners, for example, a system identifies instances of database columns or other classified data substructures within the computing environment and accesses those substructures to transform data within the substructures into encoded signatures that each collectively represent the data items from a respective substructure. Signatures from the various substructures can be compared to identify similarity metrics, to determine whether data in one substructure is similar to data in one or more other substructures. As an example, this can be useful to identify where sensitive data has been copied across storage locations without having to track individual read/write operations within the computing environment.

It is noted that examples are discussed below in the context of cloud environments and cloud storage. Further, examples are discussed in the context of database tables that store data in a plurality of columns. It is noted that these examples are described for sake of illustration, and not by limitation. Other types of computing environments, data stores, data structures, and/or classified data substructures are within the scope of the present disclosure.

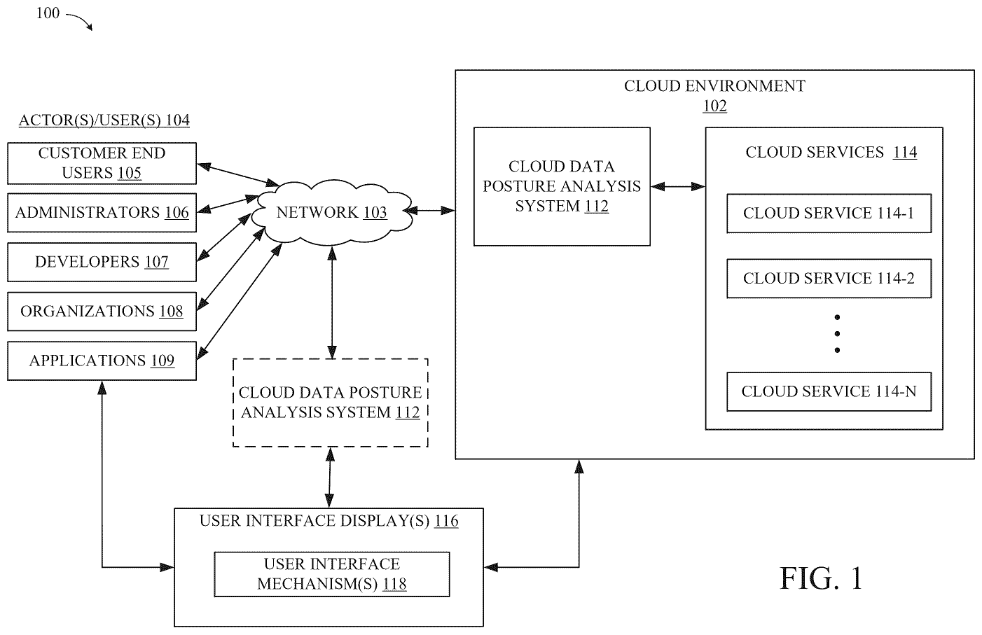

FIG. 1 is a block diagram illustrating one example of a cloud architecture 100 in which a cloud environment 102 is accessed by one or more actors 104, which can include endpoints and/or systems, through a network 103, such as the Internet or other wide area network. Cloud environment 102 includes one or more cloud services 114-1, 114-2, 114-N, collectively referred to as cloud services 114. As noted above, cloud services 114 can include cloud accounts and/or cloud storage services such as, but not limited to, AWS, GCP, Microsoft Azure, to name a few.

Further, cloud services 114-1, 114-2, 114-N can include the same type of cloud service, or can be different types of cloud services, and can be accessed by any of a number of different actors 104. For example, as illustrated in FIG. 1, actors 104 include users, which can include human users as well as non-human users, such as service accounts, system users, bots/automated users or other types of machine users. Examples of users include, but are not limited to, customer end users 105, administrators 106, developers 107, organizations 108, and/or applications 109. Of course, other users can access cloud environment 102 as well.

Cloud architecture 100 includes a cloud data posture analysis system 112 configured to access cloud services 114 to identify and analyze cloud security posture data. Examples of system 112 are discussed in further detail below. Briefly, however, system 112 is configured to access cloud services 114 and identify connected resources, entities, actors, etc. within those cloud services, and to identify risks and violations against access to sensitive information. As shown in FIG. 1, system 112 can reside within cloud environment 102 or outside cloud environment 102, as represented by the dashed box in FIG. 1. Of course, system 112 can be distributed across multiple items inside and/or outside cloud environment 102.

Actor(s) 104, can interact with cloud environment 102 through user interface displays 116 having user interface mechanisms 118. For example, a user can interact with user interface displays 116 provided on a user device (such as a mobile device, a laptop computer, a desktop computer, etc.) either directly or over network 103. Cloud environment 102 can include other items as well.

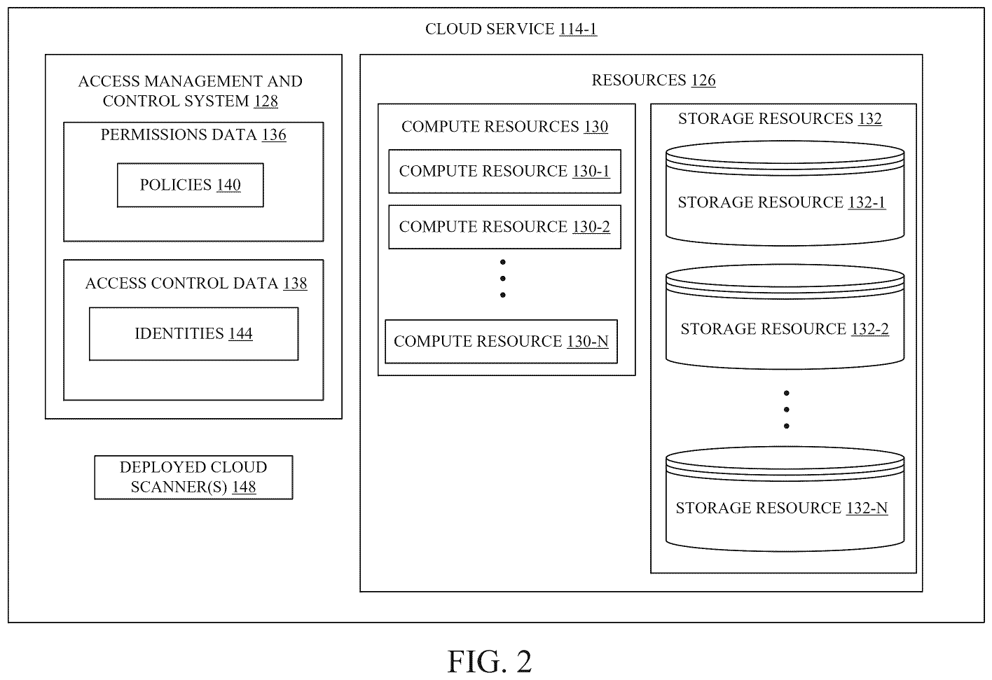

FIG. 2 is a block diagram illustrating one example of cloud service 114-1. For the sake of the present discussion, but not by limitation, cloud service 114-1 will be discussed in the context of an account within AWS. Of course, other types of cloud services and providers are within the scope of the present disclosure.

Cloud service 114-1 includes a plurality of resources 126 and an access management and control system 128 configured to manage and control access to resources 126 by actors 104. Resources 126 include compute resources 130, storage resources 132, and can include other resources. Compute resources 130 include a plurality of individual compute resources 130-1, 130-2, 130-N, which can be the same and/or different types of compute resources. In the present example, compute resources 130 can include elastic compute resources, such as elastic compute cloud (AWS EC2) resources, AWS Lambda, etc.

Storage resources 132 are accessible through compute resources 130, and can include a plurality of storage resources 132-1, 132-2, 132-N, which can be the same and/or different types of storage resources. A storage resource 132 can be defined based on object storage which stores a plurality of data objects. For example, AWS Simple Storage Service (S3) provides highly-scalable cloud object storage with a simple web service interface. An S3 object can contain both data and metadata, and objects can reside in containers called buckets. Each bucket can be identified by a unique user-specified key or file name. A bucket can be a simple flat folder without a file system hierarchy. A bucket can be viewed as a container, such as a folder, for objects, such as files, stored in the S3 storage resource.

Storage resources 132 can include data structures having a plurality of classified data substructures. Classified data substructures refer to organized segments within a larger data framework that have been identified and/or categorized based on specific criteria or attributes. These substructures can take various forms, such as tables, columns, records, fields, or any other logical grouping of data elements within a database or data store. In one example, the classification is based on data characteristics, such as data type, sensitivity, or relevance to certain operations or queries.

For instance, a plurality of databases have one or more tables. The tables include classified data substructures in the form of one or more columns that store different types of information, each with a distinct label or heading that describes the nature of the data contained within.

Accordingly, in one example, storage resources 132 include a plurality of database columns, where each column is classified via column labels or headings that can include descriptive names and/or type assigned to each column to categorize and organize the data contained therein. Examples of column types include strings, integers, etc., which represent the types of data stored in the respective column. Of course, the data substructures can be classified in other ways as well.

Compute resources 130 can access or otherwise interact with storage resources 132 through network communication paths based on permissions (or privileges) data 136 and/or access control data 138. In one example, system 128 includes identity and access management (IAM) functionality that controls access to cloud service 114-1 using entities, such as IAM entities, provided by the cloud computing platform.

Permissions data 136 includes policies 140. Permissions data 136 represents permissions, or privileges, that define what actions users or other actors can perform relative to certain cloud resources. The terms permissions or privileges will be used interchangeably in some examples described herein. Examples of permissions or privileges include, but are not limited to, open, read, write, and delete operations.

Access control data 138 includes identities 144 and associated attributes that define and manage access to cloud resources. Examples of identities 144 include, but are not limited to, various identity types, such as users, groups, and roles, each with specific permissions and access rights. In the context of AWS, for example, an IAM user is an entity created within the AWS service that represents a person or service interacting with the cloud service.

Policies 140 can include identity-based policies that are attached to IAM identities that can grant permissions to the identity. Policies 140 can also include resource-based policies that are attached to resources 126. Examples include S3 bucket policies and IAM role trust policies.

Cloud service 114-1 includes one or more deployed cloud scanners 148. Cloud scanner 148 runs locally on the cloud-based services and the server systems, and can utilize elastic compute resources, such as, but not limited to, AWS Lambda resources. In this context, locally means that the scanner is running within the cloud service itself, using cloud-native resources, such as virtual machines, containers, and/or serverless functions, rather than an external system or a third-party SaaS scanner.

Cloud scanner 148 is configured to access and scan the cloud service 114-1 on which the scanner is deployed. Examples are discussed in further detail below. Briefly, however, a scanner accesses the data stored in storage resources 132, permissions data 136, and access control data 138 to identify particular data patterns (such as, but not limited to, sensitive string patterns) and traverse or trace network communication paths between pairs of compute resources 130 and storage resources 132. The results of the scanner can be utilized to identify subject vulnerabilities, such as resources vulnerable to a breach attack, and to construct a cloud attack surface graph or other data structure that depicts propagation of a breach attack along the network communication paths.

Given a graph of connected resources, such as compute resources 130, storage resources 132, entities such as accounts, roles, policies, etc., and actors such as end users, administrators, etc., risks and violations against access to sensitive information are identified. A directional graph can be built to capture nodes that represent the resources and labels that are assigned for search and retrieval purposes. For example, a label can mark the node as a database or S3 resource, actors as end users, administrators, developers, etc. Relationships between the nodes are created using information available from the cloud infrastructure configuration. For example, using the configuration information, system 112 can determine that a resource belongs to a given account and create a relationship between the policy attached to a resource and/or identify the roles that can be taken up by a user.

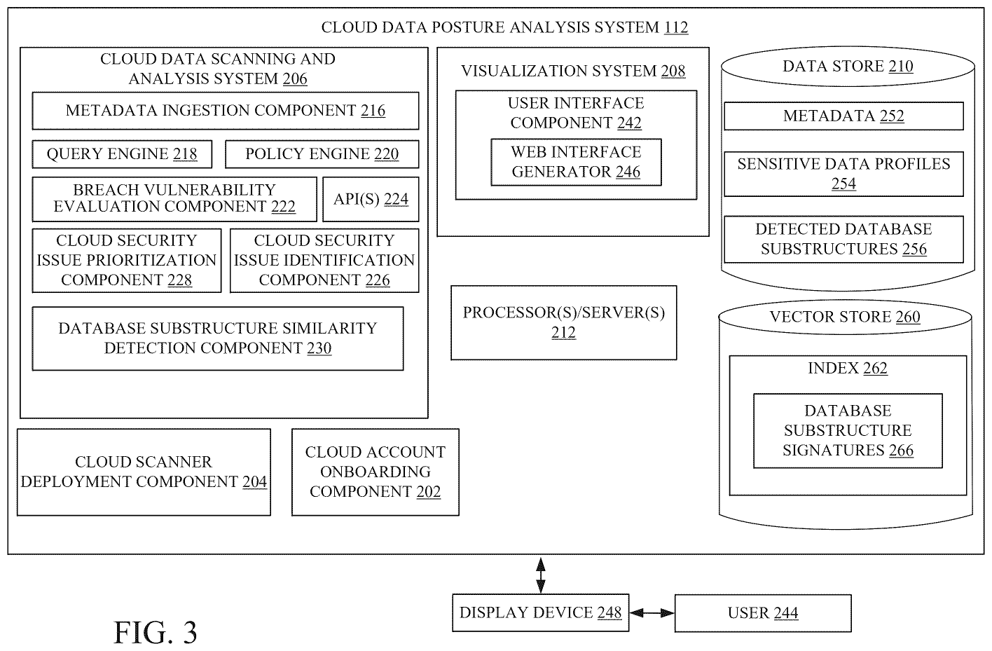

FIG. 3 is a block diagram illustrating one example of cloud data posture analysis system 112. As noted above, system 112 can be deployed in cloud environment 102 and/or access cloud environment 102 through network 103 shown in FIG. 1.

System 112 includes a cloud account onboarding component 202, a cloud scanner deployment component 204, a cloud data scanning and analysis system 206, a visualization system 208, and a data store 210. System 112 can also include one or more processors or servers 212, and can include other items as well.

Cloud account onboarding component 202 is configured to onboard cloud services 114 for analysis by system 112. After onboarding, cloud scanner deployment component 204 is configured to deploy a cloud scanner, such as cloud scanner(s) 148 shown in FIG. 2, to the cloud service. In one example, the deployed scanners are on-demand agent-less scanners configured to perform agent-less scanning within the cloud service. One example of an agent-less scanner does not require agents to be installed on each specific device or machine. The scanners operate on resources 126 and access management and control system 128 directly within the cloud service, and generate metadata that is returned to system 112. Thus, in one example, the actual cloud service data is not required to leave the cloud service for analysis.

Cloud data scanning and analysis system 206 includes a metadata ingestion component 216 configured to receive the metadata generated by the deployed cloud scanner(s) 148. System 206 also includes a query engine 218, a policy engine 220, a breach vulnerability evaluation component 222, one or more application programming interfaces (APIs) 224, a cloud security issue identification component 226, a cloud security issue prioritization component 228, a database substructure similarity detection component 230, and can include other items as well.

Query engine 218 is configured to execute queries against the received metadata and the generated cloud security issue data. Policy engine 220 can execute security policies against the cloud data and the breach vulnerability evaluation component 222 is configured to evaluate potential breach vulnerabilities in the cloud service. APIs 224 are exposed to users, such as administrators, to interact with system 112 to access the cloud security posture data. Component 226 is configured to identify cloud security issues and component 228 can prioritize the identified cloud security issues based on any of a number of criteria.

Visualization system 208 is configured to generate visualizations of the cloud security posture from system 206. Illustratively, system 208 includes a user interface component 242 configured to generate a user interface for a user 244, such as an administrator. In the illustrated example, component 242 includes a web interface generator 246 configured to generate web interfaces that can be displayed on a display device 248 in a web browser on a client device. Visualization system 208 can include other items as well.

Data store 210 stores metadata 252 obtained by metadata ingestion component 216, and can include other items as well. Examples of sensitive data profiles 254 are discussed in further detail below. Briefly, however, sensitive data profiles 254 can identify target data patterns that are to be categorized as sensitive or conforming to a predefined pattern of interest. Sensitive data profiles 254 can be used as training data for data classification performed by system 206. For example, pattern matching can be performed based on target data profiles. Illustratively, pattern matching can be performed to identify instances of data patterns corresponding to social security numbers, credit card numbers, other personal data, medical information, to name a few. In one example, artificial intelligence (AI) is utilized to perform named entity recognition, such as natural language processing modules, can identify sensitive data, in various languages, representing names, company names, locations, etc.

Database substructure similarity detection component 230 is configured to detect instances of database substructures, such as columns, and data items within those substructures, and to detect similarities between the database columns based on the data items. Examples of operation of component 230 is discussed in further detail below. Briefly, however, component 230 is configured to generate, for each database column, a database column signature that collectively represents the data items in the database column and to generate similarity metrics that identify a similarity between the database column and one or more other database columns.

Detected database substructure records 256, generated by component 230, store detected instances of the database columns in the computing environment under analysis, such as cloud environment 102. An example detected database substructure record can store any of a variety of different data representing a detected database column, including, but not limited to, a data store identifier, a database identifier, a table name identifier, a column name identifier, and/or a column type identifier, among other data. A data store identifier identifies a particular data store that contains the detected database column. A database identifier identifies a particular database, in the particular data store, that contains the detected database column. A table name identifier identifies a particular table, in the particular database, that contains the detected database column. A column name identifier identifies the column name associated with a particular column that contains the detected instance of the target data profiles. A column type identifier identifies a data type, such as a date, integer, timestamp, character string, or decimal.

A vector store 260 stores an index 262, and can store other items as well. Index 262 is configured to store database substructure signatures 266 generated by component 230. Illustratively, an example vector database stores data as high-dimensional vectors, which include representations of features or attributes. Each vector can include a number of dimensions, which can range in number depending on the complexity and granularity of the data.

Further, similarity search and retrieval can be performed on vector store 260 using a vector query that represents a target database substructure signature. A similarity measure can be used to calculate how close or distant two or more vectors are in the vector space, and can be based on various metrics, such as a Cosine Similarity, Euclidean distance, Hamming distance, and Jaccard index, to name a few

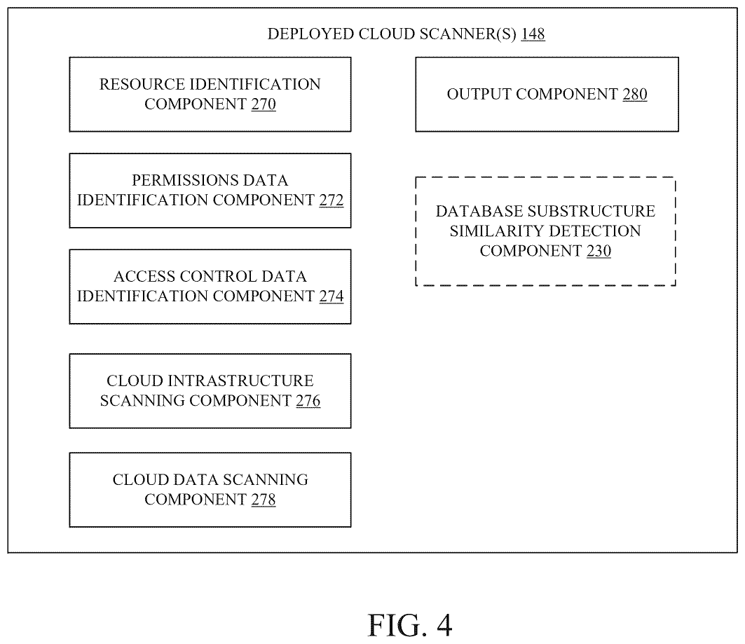

FIG. 4 is a block diagram illustrating one example of a deployed scanner 148. Scanner 148 can be deployed locally in the cloud environment using an elastic compute resource, such as an AWS lambda instance, in the cloud environment. Scanner 148 includes a resource identification component 270, a permissions data identification component 272, an access control data identification component 274, a cloud infrastructure scanning component 276, a cloud data scanning component 278, an output component 280, and can include other items as well. FIG. 4 also illustrates that some or all components of and/or functionality performed by database substructure similarity detection component 230 can be on or otherwise associated with deployed scanner 148.

Resource identification component 270 is configured to identify the resources 126 within cloud service 114-1 and/or other cloud services 114 and to generate corresponding metadata that identifies these resources. Permissions data identification component 272 identifies the permissions data 136. Access control data identification component 274 identifies access control data 138. Cloud infrastructure scanning component 276 scans the infrastructure of cloud service 114 to identify the relationships between resources 130 and 132 and cloud data scanning component 278 scans the actual data stored in storage resources 132. Output component 280 is configured to output the generated metadata and database substructure signatures to cloud data posture analysis system 112.

The metadata generated by scanner 148 can indicate a structure of schema objects in a data store. For example, where the schema objects comprise columns in a data store having a tabular format, the returned metadata can include column names from those columns. A content-based data item classifier is configured to classify data items within the schema objects, based on content of those data items.

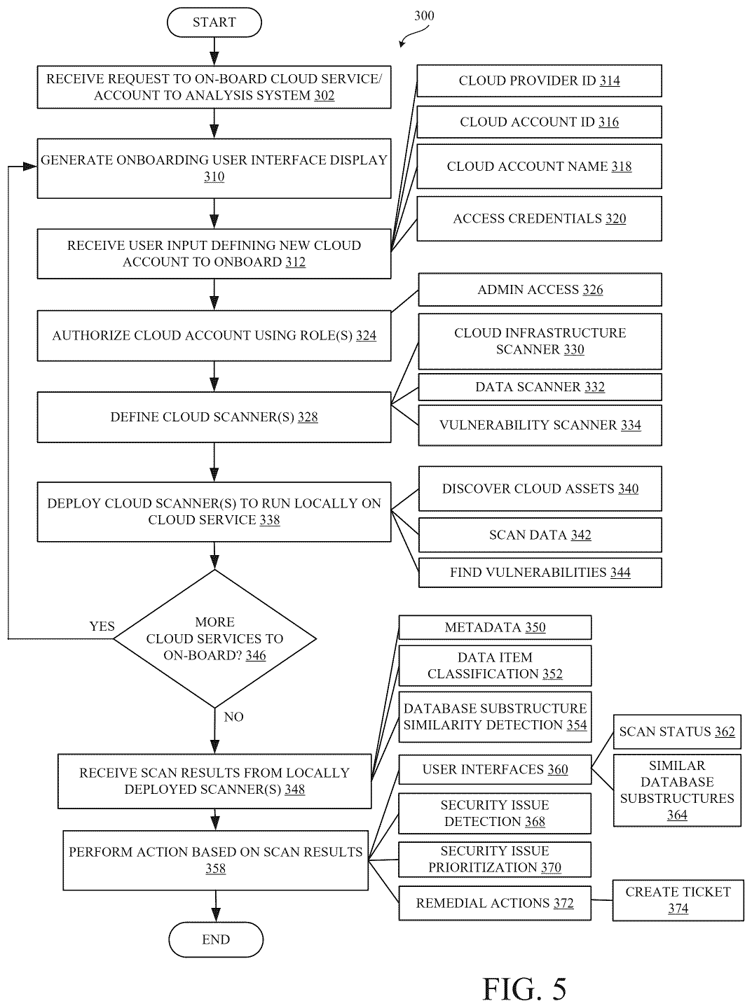

FIG. 5 is a flow diagram 300 showing an example operation of system 112 for on-boarding a cloud account and deploying one or more scanners to scan a cloud environment. At block 302, a request to on-board a cloud service to cloud data posture analysis system 112 is received. For example, an administrator can submit a request to on-board cloud service 114-1.

At block 310, an on-boarding user interface display is generated. In one example, the user interface display includes a cloud formation template.

At block 312, user input is received that defines a new cloud account to be on-boarded. The user input can define a cloud provider identification 314, a cloud account identification 316, a cloud account name 318, access credentials to the cloud account 320, and can include other input defining the cloud account to be on-boarded.

At block 324, the cloud account is authorized using roles. For example, administrator access at block 326 can be defined for the cloud scanner using IAM roles. One or more cloud scanners are defined at block 328 and can include, but are not limited to, cloud infrastructure scanners 330, cloud data scanners 332, vulnerability scanners 334, or other scanners.

At block 338, the cloud scanners are deployed to run locally on the cloud service, such as cloud service 114-1 illustrated in FIG. 2. The cloud scanners discover cloud assets at block 340. The cloud assets can include, but are not limited to, compute resources (such as elastic compute resources), storage resources, or other types of resources. At block 342, the data is scanned.

At block 344, vulnerabilities are identified based on finding a predefined risk signature in the cloud service resources. The risk signatures can be queried upon, and can define expected behavior within the cloud service and locate anomalies based on this data. A vulnerability can be identified based on finding a predefined risk signature in the cloud service resources. The risk signatures can be queried upon, and define expected behavior within the cloud service and locate anomalies based on this data.

At block 346, if more cloud services are to be on-boarded, operation returns to block 310. At block 348, the scan results from the deployed scanners are received. As noted above, the scan results include metadata at block 350, data item classification results at block 352, results of database substructure similarity detection at block 354, and can include other results as well.

At block 358, one or more actions are performed based on the scan results. For example, the action can include providing user interfaces at block 360 that indicate the scan status at block 362 and/or identify similar database substructures at block 364. For example, block 364 can include generating a user interface display that identifies, for a particular substructure, a number of other substructures, such as in the form of a numerical value, that are identified as having a similarity above a threshold, based on the comparison of the signatures generated for each substructure. The threshold can be set in any of a number of ways. For example, two substructures can be identified as similar if at least eighty percent of the data items in one substructure are found in the other substructure. The user interface can also include user input mechanisms or controls that are actuatable to navigate to the similar substructures or otherwise display details of the similar substructures.

At block 368, the action can include security issue detection. For example, a breach risk on a particular resource, such as a storage resource storing sensitive data, is identified. At block 370, security issue prioritization can be performed to prioritize the detected security issues. Examples of security issue detection and prioritization are discussed in further detail below. Briefly, security issues can be detected by executing a query against the scan results using vulnerability or risk signatures. The risk signatures identify criterion such as accessibility of the resources, access and/or permissions between resources, and data types in accessed data stores. Further, each risk signature can be scored and prioritized based impact. For example, a risk signature can include weights indicative of likelihood of occurrence of a breach and impact if the breach occurs.

Remedial actions can be taken at block 372, such as creating a ticket at block 374 for a developer or other user to address the security issues. Of course, other actions can be taken as well. For instance, the system can make adjustments to cloud account settings/configurations to address/remedy the security issues.

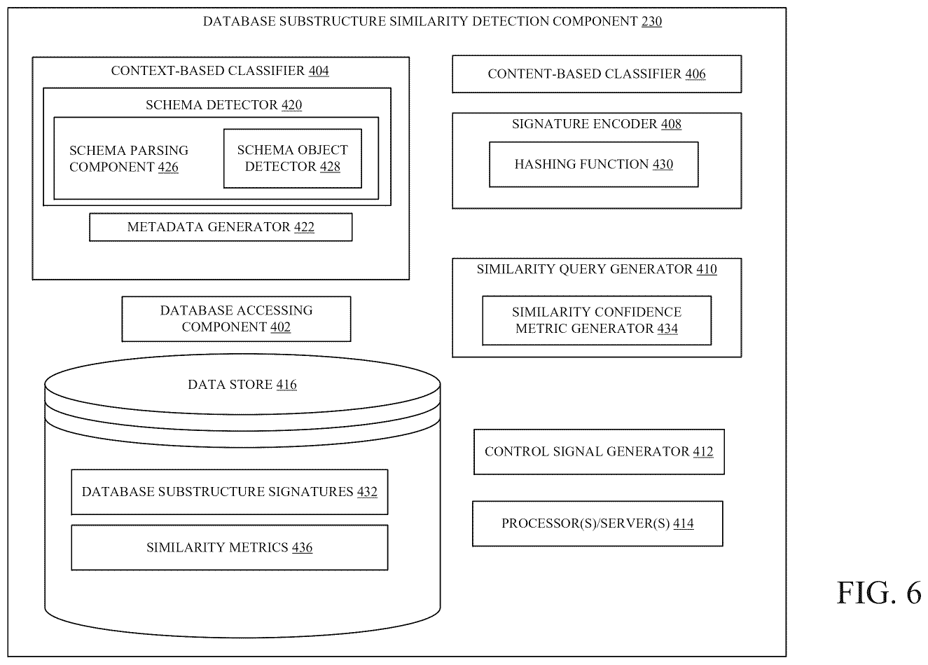

FIG. 6 illustrates one example of database substructure similarity detection component 230. Component 230 includes a database accessing component 402, a context-based classifier 404, a content-based classifier 406, a signature encoder 408, a similar query generator 410, a control signal generator 412, one or more processors or servers 414, a data store 416, and can include other items as well.

Database accessing component 402 is configured to access data stores to be analyzed. Context-based classifier 404 includes a schema detector 420, a metadata generator 422, and can include other items as well. Schema detector 420 is configured to detect a schema used by the data store, and includes a schema parsing component 426, which includes a schema object detector 428. Schema object detector 428 identifies the particular schema objects in the database structure and metadata generator 422 generates metadata that identifies the detected schema objects along with relationship data that identifies relationships between those schema objects. The metadata can be stored in data store 416. The metadata provides a level of context, such as database substructure names, substructure types, etc.

Signature encoder 408 is configured to access data items in a given database substructure and to generate a database substructure signature that collectively represents the data items from the given database substructure. Illustratively, signature encoder 408 includes a vector generator configured to generate an encoded vector of values based on the data items in the substructure. The vector generator can include, for example, a hashing function 430. One example of a hashing function is a MinHash function, which is a min-wise independent permutation for estimating similarity of two data sets. The Minhash function applies a hash function to each element of the data set and then selects the minimum hash value as the representative signature of the set. This process is repeated multiple times with different hash functions to create a signature matrix. The similarity between two sets can then be estimated by comparing the MinHash signatures of the two sets. Specifically, the similarity is calculated as the fraction of hash functions for which the MinHash values of the two sets are equal. This fraction is an unbiased estimator of a Jaccard similarity between the sets, which is defined as the size of the intersection divided by the size of the union of the sets.

For sake of illustration, but not by limitation, a Jaccard similarity coefficient can be used to indicate similarity between a first database substructure and a second database substructure, as shown below:

$$J ( A , B ) = \frac{\vert A ⋂ B \vert}{\vert A ⋃ B \vert} ,$$

where U is a set and A (data items of the first database substructure) and B (data items of the second database substructure) are subsets of U. The Jaccard index is defined to be the ratio of the number of elements of their intersection and the number of elements of their union. The value is zero when the two sets are disjoint, the value is one when the two sets are equal, and the value is between zero and one otherwise. When the two substructures are more similar, that is the substructures have more data items in common, the Jaccard index is closer to one. A hash function h maps the members of U to distinct integers. For any subset S of U, hₘᵢₙ(S) is defined to be the minimal member of S with respect to h times a random permutation of the elements of the set U:

Pr[hₘᵢₙ(0.4)=/hₘᵢₙ(B)]=J(A,B), where the probability that hₘᵢₙ(A)=hₘᵢₙ(B) is true is equal to the similarity J(A,B), assuming the random permutation is drawn from a uniform distribution.

The signature generated by signature encoder 408 can be stored in data store 416 as database substructure signatures 432.

Similarity query generator 410 is configured to access the database substructure signatures and to identify similar substructures based on those signatures. For example, generator 410 can include a similarity confidence metric generator 434 configured to generate a confidence metric based on a comparison of two or more database substructure signatures. The metrics generated by generator 434 can be stored in data store 416 as similarity metrics 436. Data store 416 can store other items as well.

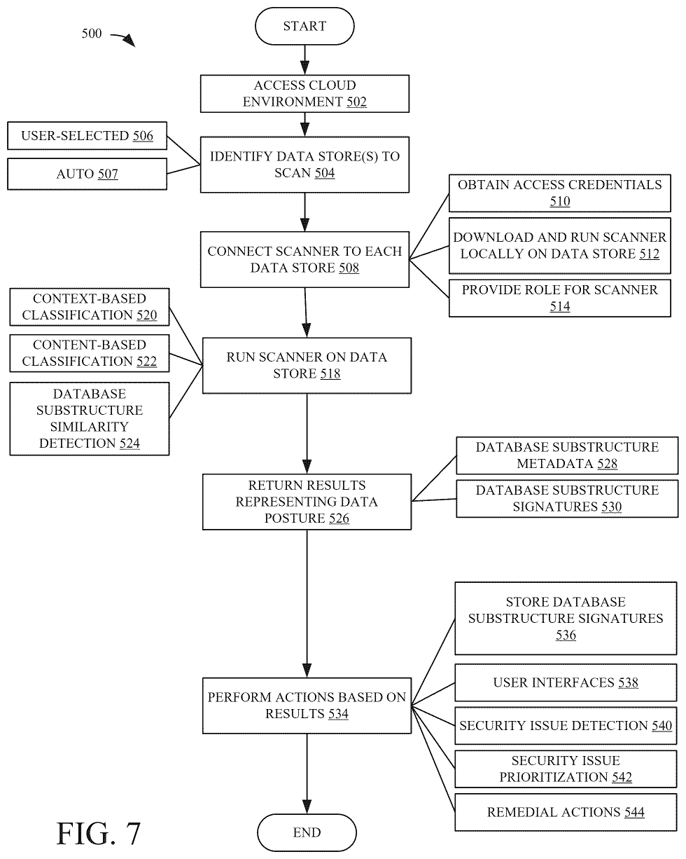

FIG. 7 is a flow diagram 500 illustrating one example of scanning data stores in computing environment, such as a cloud environment. For sake of illustration, but not by limitation, FIG. 7 will be discussed in the context of cloud data posture analysis system 112.

At block 502, system 112 accesses a cloud account in a cloud environment onboarded by cloud account onboarding component 202. At block 504, one or more data stores to scan are identified. The data stores can be user selected at block 506 and/or automatically selected at block 507, for example by system 112 using a selection criterion.

At block 508, a scanner is connected to each data store to be scanned. Block 508 can include obtaining access credentials at block 510, downloading and running the scanner locally on the data store at block 512, providing a role to the scanner to access the data store at block 514, and can include other items as well.

At block 518, the scanner is run on the data store to identify one or more data structures and to perform a scan of the one or more data structures. At block 520, context-based classification is performed using metadata to identify schema objects or other substructures, within the data structures, and relationships between those substructures. The metadata can be generated during and/or obtained based on the scan at block 518. For instance, the metadata can be predefined and stored within the data structure.

At block 522, content-based classification is performed to classify the content of the data items within the identified substructures. In one example, the content-based classification examines the intrinsic properties of the data, such as the format, patterns, and/or semantic meaning of the data. For instance, content-based classification can use algorithms to identify specific data patterns, such as sequences of numbers that resemble credit card numbers or social security numbers, or text patterns that match known sensitive information like personal names or addresses. The classification can also employ machine learning techniques, such as natural language processing (NLP), to understand and categorize data based on the content.

At block 524, database substructure similarity detection is performed. Examples are discussed in further detail below. Briefly, however, using the data items retrieved from the substructure, a signature encoder generates a respective database substructure signature that collectively represents a plurality of data items from the substructure. Using this signature, the substructure can be compared to one or more other substructures to determine whether there is a threshold level of similarity.

In one example, one or more of blocks 520, 522, and 522 are performed by the deployed scanner. Alternatively, or in addition, some or all of blocks 520, 522, and 522 are performed by a component that receives results from the deployed scanner.

At block 526, results are returned representing the data posture. For example, database substructure metadata can be returned at block 528, the database substructure signatures can be returned at block 530, and other results can be returned. The metadata at block 528 can include labels or tags identifying the substructure name, substructure type, etc.

At block 534, one or more actions can be performed based on the results. Block 534 can include, but is not limited to, storing the database substructure signatures in association with the respective data substructures at block 536, displaying one or more user interfaces at block 538, performing security issue detection at block 540, performing security issue prioritization at block 542, performing one or more remedial actions at block 544, or other actions. In one example, at block 536, the database substructure signatures are indexed in a vector database.

In one example of block 536, the database substructure signatures are stored in association with the substructures by creation of a persistent link between the generated data structure signatures and their corresponding data substructures within a database or data management system. For instance, a unique representation of the data items within a substructure is systematically cataloged alongside the substructure. This facilitates retrieval and utilization of the signatures for various operations, such as similarity queries, data analysis, and security assessments. The association between signatures and substructures is maintained, in one example, in a structured format, such as a vector database, where each entry includes both the signature and metadata identifying the substructure, such as its name, type, and location within the data framework.

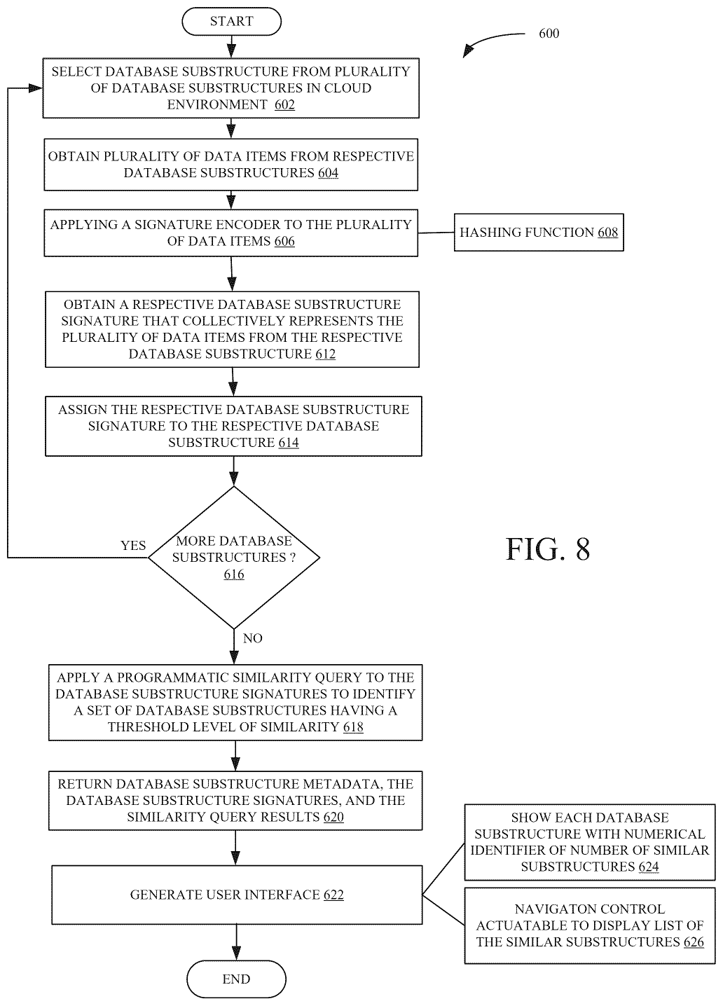

FIG. 8 is a flow diagram 600 illustrating one example of scanning database substructures and performing database substructure similarity detection, performed for example with respect to blocks 518 and 524 in FIG. 7.

At block 602, a database substructure is selected from a plurality of database substructures in the cloud environment. At block 604, a plurality of data items from the respective database substructure are obtained. For instance, the data items can include a number of data rows within the respective database substructure.

The plurality of data items is transformed by converting raw data from the data substructure into a format that can be effectively analyzed and compared. In one example, the process includes encoding the data items into a signature that collectively represents the entire data structure. The transformation is achieved using a signature encoder, which applies mathematical functions or algorithms to generate a unique representation of the data items. This encoded signature facilitates efficient similarity queries and comparisons between different data structures by reducing the complexity and dimensionality of the data.

In one example, at block 606, the signature encoder is applied to the plurality of data items in the respective database substructure. An example signature encoder is a hashing function at block 608, or other signature encoders. Examples of hashing functions, such as a MinHash function, are discussed above. At block 612, a database substructure signature is obtained that collectively represents the plurality of data items from the respective database substructure. The substructure signature is assigned to the respective database substructure at block 614.

If there are more database substructures to analyze at block 616, operation returns to block 602. Once all database substructures have been selected to obtain and assign a respective database substructure signature, operation proceeds to block 618 which applies a similarity query to the database substructure signatures to identify a set of database substructures having a threshold level of similarity. In one example, the similarity query is programmatically executed through software algorithms and scripts to automatically execute queries against a database or data structure, with little or no need for manual intervention.

At block 620, the database substructure metadata, the database substructure signatures, and/or the similarity query results are returned. At block 622, a user interface can be generated. One example includes a user interface that shows each database substructure with a numerical identifier that indicates a number of similar substructures, that are similar to the database substructure, as represented at block 624. Alternatively, or in addition, a navigation control can be provided that is actuatable to display a list of the similar substructures. Of course, other user interfaces can be generated as well.

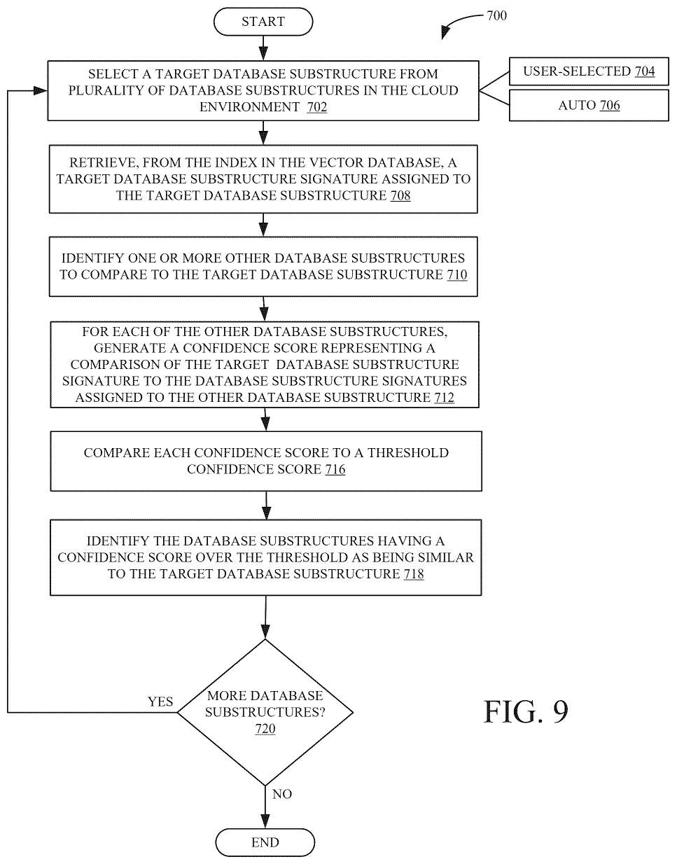

FIG. 9 is a flow diagram 700 that illustrates one example of determining database substructure similarity at block 618. At block 702, a target database substructure is selected from a plurality of database substructures in the cloud environment. The target database substructure can be user selected at block 704, or automatically selected at block 706.

A target database substructure signature that is assigned to the target database substructure is retrieved from the index in the vector database, as represented at block 708. One or more other database substructures are identified at block 710 to compare to the target database substructure. At block 712, for each of the other database substructures, a confidence score is generated representing a comparison of the target database substructure signature to the database substructure signatures assigned to the other database substructures.

At block 716, each confidence score generated at block 712 is compared to a threshold confidence score. At block 718, any database substructures having a confidence score over the threshold confidence score are identified as being similar to the target database substructure.

In one example, the process of generating a confidence score involves comparing the signatures of two data substructures to determine their level of similarity using a MinHash technique, which estimates the similarity between two sets by comparing their MinHash signatures. The MinHash function applies multiple hash functions to the data items in each substructure, creating a signature matrix for each. The confidence score is calculated as the fraction of hash functions for which the MinHash values of the two substructures are equal. This fraction serves as an unbiased estimator of the Jaccard similarity, which measures the size of the intersection divided by the size of the union of the sets. The confidence score provides a quantitative measure of how similar the data substructures are, with higher scores indicating greater similarity. The confidence score is compared to a predefined threshold confidence score to determine if the data substructures have a sufficient level of similarity. The threshold confidence score is a predetermined value that represents the minimum acceptable similarity for the substructures to be considered similar. If the confidence score exceeds this threshold confidence score, the substructures are deemed to have the required level of similarity, indicating that they share a minimum threshold amount of data.

At block 720, the method determines whether there are more database substructures to analyze for similarities. If so, operation returns to block 702.

It can thus be seen that the present disclosure describes technology for data posture management by performing substructure signature generation and data substructure similarity detection. Signatures that represent each database substructure are generated and can be indexed in a vector database, for subsequent retrieval and comparison to identify substructures that have threshold similarity. In this way, data of interest, such as sensitive data, that has been copied or otherwise resides in other locations in the computing environment can be easily identified, without requiring error prone manual intervention or tracking individual read/write operations within the computing environment. This improves data posture management within the computing environment.

One or more implementations of the technology disclosed or elements thereof can be implemented in the form of a computer product, including a non-transitory computer readable storage medium with computer usable program code for performing the method steps indicated. Furthermore, one or more implementations and clauses of the technology disclosed or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

Examples discussed herein include processor(s) and/or server(s). For sake of illustration, but not by limitation, the processors and/or servers include computer processors with associated memory and timing circuitry, and are functional parts of the corresponding systems or devices, and facilitate the functionality of the other components or items in those systems.

As used herein, if a description includes “one or more of” or “at least one of” followed by a list of example features with a conjunction “or” between the penultimate example feature and the last example feature, then this is to be read such that (1) one exemplary embodiment includes at least one of or one or more of each feature of the listed features, (2) another exemplary embodiment includes at least one of or one or more of only one feature of the listed features, and (3) another exemplary embodiment includes some combination of the listed features that is less than all of the features and more than one of the features.

As used herein, if a description includes “one or more of” or “at least one of” followed by a list of example features with a conjunction “and” between the penultimate example feature and the last example feature, then this is to be read such that the exemplary embodiment includes at least one of or one or more of each feature of all the listed features.

As used herein, if a description includes “one or more of” or “at least one of” followed by a list of example features with a conjunction “and/or” between the penultimate example feature and the least example feature, then this is to be read such that, in one example, the description includes “one or more of” or “at least one of” followed by a list of example features with a conjunction “or” between the penultimate example feature and the last example feature, and, in another example, the description includes “one or more of” or “at least one of” followed by a list of example features with a conjunction “and” between the penultimate example feature and the last example feature.

Also, user interface displays have been discussed. Examples of user interface displays can take a wide variety of forms with different user actuatable input mechanisms. For instance, a user input mechanism can include icons, links, menus, text boxes, check boxes, etc., and can be actuated in a wide variety of different ways. Examples of input devices for actuating the input mechanisms include, but are not limited to, hardware devices (e.g., point and click devices, hardware buttons, switches, a joystick or keyboard, thumb switches or thumb pads, etc.) and virtual devices (e.g., virtual keyboards or other virtual actuators). For instance, a user actuatable input mechanism can be actuated using a touch gesture on a touch sensitive screen. In another example, a user actuatable input mechanism can be actuated using a speech command.

The present figures show a number of blocks with corresponding functionality described herein. It is noted that fewer blocks can be used, such that functionality is performed by fewer components. Also, more blocks can be used with the functionality distributed among more components. Further, the data stores discussed herein can be broken into multiple data stores. All of the data stores can be local to the systems accessing the data stores, all of the data stores can be remote, or some data stores can be local while others can be remote.

The above discussion has described a variety of different systems, components, logic, and interactions. One or more of these systems, components, logic and/or interactions can be implemented by hardware, such as processors, memory, or other processing components. Some particular examples include, but are not limited to, artificial intelligence components, such as neural networks, that perform the functions associated with those systems, components, logic, and/or interactions. In addition, the systems, components, logic and/or interactions can be implemented by software that is loaded into a memory and is executed by a processor, server, or other computing component, as described below. The systems, components, logic and/or interactions can also be implemented by different combinations of hardware, software, firmware, etc., some examples of which are described below. These are some examples of different structures that can be used to implement any or all of the systems, components, logic, and/or interactions described above.

The elements of the described figures, or portions of the elements, can be disposed on a wide variety of different devices. Some of those devices include servers, desktop computers, laptop computers, tablet computers, or other mobile devices, such as palm top computers, cell phones, smart phones, multimedia players, personal digital assistants, etc.

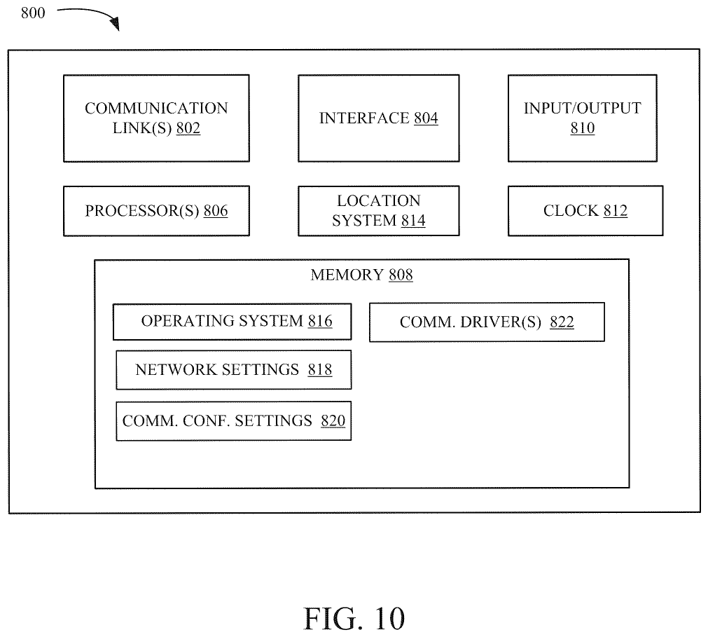

FIG. 10 is a simplified block diagram of one example of a client device 800, such as a handheld or mobile device, in which the present system (or parts of the present system) can be deployed.

One or more communication links 802 allows device 800 to communicate with other computing devices, and can provide a channel for receiving information automatically, such as by scanning. An example includes communication protocols, such as wireless services used to provide cellular access to a network, as well as protocols that provide local wireless connections to networks.

Applications or other data can be received on an external (e.g., removable) storage device or memory that is connected to an interface 804. Interface 804 and communication links 802 communicate with one or more processors 806 (which can include processors or servers described with respect to the figures) along a communication bus (not shown in FIG. 10), that can also be connected to memory 808 and input/output (I/O) components 810, as well as clock 812 and a location system 814.

Components 810 facilitate input and output operations for device 800, and can include input components such as microphones, touch screens, buttons, touch sensors, optical sensors, proximity sensors, orientation sensors, accelerometers. Components 810 can include output components such as a display device, a speaker, and or a printer port.

Clock 812 includes, in one example, a real time clock component that outputs a time and date, and can provide timing functions for processor 806. Location system 814 outputs a current geographic location of device 800 and can include a global positioning system (GPS) receiver, a LORAN system, a dead reckoning system, a cellular triangulation system, or other positioning system. Memory 808 stores an operating system 816, network applications and corresponding configuration settings 818, communication configuration settings 820, communication drivers 822, and can include other items. Examples of memory 808 include types of tangible volatile and non-volatile computer-readable memory devices. Memory 808 can also include computer storage media that stores computer readable instructions that, when executed by processor 806, cause the processor to perform computer-implemented steps or functions according to the instructions. Processor 806 can be activated by other components to facilitate functionality of those components as well.

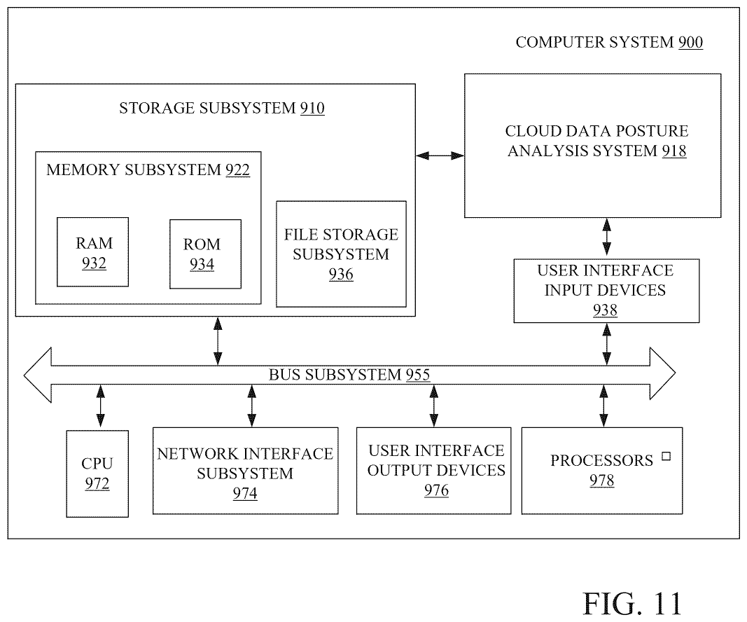

FIG. 11 shows an example computer system 900 that can be used to implement the technology disclosed. Computer system 900 includes at least one central processing unit (CPU) 972 that communicates with a number of peripheral devices via bus subsystem 955. These peripheral devices can include a storage subsystem 910 including, for example, memory devices and a file storage subsystem 936, user interface input devices 938, user interface output devices 976, and a network interface subsystem 974. The input and output devices allow user interaction with computer system 900. Network interface subsystem 974 provides an interface to outside networks, including an interface to corresponding interface devices in other computer systems.

In one implementation, cloud data posture analysis system 918 is communicably linked to the storage subsystem 910 and the user interface input devices 938. System 918 can include some or all components of system 112, discussed above.

User interface input devices 938 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 900.

User interface output devices 976 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 900 to the user or to another machine or computer system.

Storage subsystem 910 stores programming and data constructs that provide the functionality of some or all of the modules and methods described herein. These software modules are generally executed by processors 978.

Processors 978 can be graphics processing units (GPUs), field-programmable gate arrays (FPGAs), application-specific integrated circuits (ASICs), and/or coarse-grained reconfigurable architectures (CGRAs). Processors 978 can be hosted by a deep learning cloud platform such as Google Cloud Platform™, Xilinx™, and Cirrascale™

Memory subsystem 922 used in the storage subsystem 910 can include a number of memories including a main random access memory (RAM) 932 for storage of instructions and data during program execution and a read only memory (ROM) 934 in which fixed instructions are stored. A file storage subsystem 936 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 936 in the storage subsystem 910, or in other machines accessible by the processor.

Bus subsystem 955 provides a mechanism for letting the various components and subsystems of computer system 900 communicate with each other as intended. Although bus subsystem 955 is shown schematically as a single bus, alternative implementations of the bus subsystem can use multiple busses.

Computer system 900 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 900 depicted in FIG. 11 is intended only as a specific example for purposes of illustrating the preferred implementations of the present invention. Many other configurations of computer system 900 are possible having more or less components than the computer system depicted in FIG. 11.

It should also be noted that the different examples described herein can be combined in different ways. That is, parts of one or more examples can be combined with parts of one or more other examples. All of this is contemplated herein.

The technology disclosed can be practiced as a system, method, or article of manufacture. One or more features of an implementation can be combined with the base implementation. Implementations that are not mutually exclusive are taught to be combinable.

One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for detecting data posture of a computing environment, the computer-implemented method comprising:
performing a scan of one or more data structures in the computing environment;
detecting a plurality of classified data substructures based on the scan of the one or more data structures;
for each respective data substructure of the plurality of classified data substructures, transforming a plurality of data items from the respective data substructure into a respective data substructure signature using a signature encoder; and
applying a similarity query to identify a set of data substructures, from the plurality of classified data substructures, having a threshold level of similarity based on data substructure signatures associated with the set of data substructures.

2. The computer-implemented method of claim 1, wherein the plurality of classified data substructures comprises a plurality of data columns.

3. The computer-implemented method of claim 2, wherein the computing environment comprises a cloud environment having a plurality of databases that include the plurality of data columns.

4. The computer-implemented method of claim 2, wherein
detecting the plurality of classified data substructures comprises, for each respective data column of the plurality of data columns, receiving:
a column name of the respective data column,
a column type of the respective data column, and
a set of rows from the respective data column; and
transforming the plurality of data items comprises:
generating an encoded vector of values based on data items in the set of rows.

5. The computer-implemented method of claim 1, wherein applying the similarity query comprises:
obtaining a first data substructure signature assigned to a first data substructure;
obtaining a second data substructure signature assigned to a second data substructure;
generating a confidence score representing a comparison of the first data substructure signature and the second data substructure signature;
comparing the confidence score to a threshold confidence score; and
determining that the first data substructure has the threshold level of similarity to the second data substructure based on the confidence score exceeding the threshold confidence score.

6. The computer-implemented method of claim 1, wherein transforming the plurality of data items comprises applying a function to encode the plurality of data items into a vector array of values that collectively represent the respective data substructure.

7. The computer-implemented method of claim 6, wherein the function comprises a hashing function.

8. The computer-implemented method of claim 7, wherein the hashing function comprises a MinHash function.

9. The computer-implemented method of claim 1, and further comprising generating an index of data substructure signatures that represent the plurality of classified data substructures.

10. The computer-implemented method of claim 9, wherein the index is stored in a vector database.

11. The computer-implemented method of claim 10, wherein the similarity query is applied to the vector database.

12. The computer-implemented method of claim 1, further comprising generating a user interface display that displays results of the similarity query.

13. The computer-implemented method of claim 12, wherein the user interface display includes a numerical display element that corresponds to a first data substructure, of the plurality of classified data substructures, and identifies a number of other data substructures that are similar to the first data substructure.

14. The computer-implemented method of claim 1, wherein performing the scan comprises deploying a scanner locally in the computing environment, and further comprising receiving results of the scanner at a computing system external to the computing environment.

15. A system for detecting data posture of a computing environment, the system comprising:
a processor; and
memory accessible by the processor, the memory including instructions executable to:
perform a scan of one or more data structures in the computing environment;
detect a plurality of classified data substructures based on the scan of the one or more data structures;
for each respective data substructure of the plurality of classified data substructures, transform a plurality of data items from the respective data substructure into a respective data substructure signature using a signature encoder; and
apply a similarity query to identify a set of data substructures, from the plurality of classified data substructures, having a threshold level of similarity based on data substructure signatures associated with the set of data substructures.

16. The system of claim 15, wherein the instructions are executable to apply the similarity query by obtaining a first data substructure signature assigned to a first data substructure, obtaining a second data substructure signature assigned to a second data substructure, generating a confidence score representing a comparison of the first data substructure signature and the second data substructure signature, comparing the confidence score to a threshold confidence score, and determining that the first data substructure has the threshold level of similarity to the second data substructure based on the confidence score exceeding the threshold confidence score.

17. The system of claim 15, wherein the plurality of classified data substructures comprises a plurality of data columns, and each data substructure signature collectively represents a plurality of data items from a respective data substructure.

18. A method performed by a computing system, the method comprising:
identifying a plurality of database columns in one or more storage resources;
for each respective database column of the plurality of database columns,
obtaining a plurality of data items from the respective database column;
generating an encoded value vector that represents the respective database column by signature encoding the plurality of data items; and
storing the encoded value vector in a vector database;
querying the vector database using a target value vector associated with a target database column; and
identifying one or more database columns having a threshold level of similarity to the target database column based on the target value vector and the encoded value vectors stored in the vector database.

19. The method of claim 18, wherein identifying the one or more database columns comprises:
obtaining a first database column signature assigned to a first database column;
obtaining a second database column signature assigned to a second database column;
generating a confidence score representing a comparison of the first database column signature and the second database column signature;
comparing the confidence score to a threshold confidence score; and
determining that the first database column has the threshold level of similarity to the second database column based on the confidence score exceeding the threshold confidence score.

20. The method of claim 18, wherein generating the encoded value vector comprises applying a hashing function to the plurality of data items.
